(19) United States
(12) Patent Application Publication
(10) Pub. No.: US 2020/0348046 A1
(43) Pub. Date: Nov. 5, 2020

(54) HEATING DEVICE, PARTICULARLY FOR AIR CONDITIONING HOUSING OF A MOTOR VEHICLE

(71) Applicant: Valeo Systemes Thermiques, Le Mesnil-Saint-Denis Cedex (FR)

(72) Inventor: Frédéric Pierron, Le Mesnil Saint Denis Cedex (FR)

(73) Assignee: Valeo Systemes Thermiques, Le Mesnil-Saint-Denis Cedex (FR)

(21) Appl. No.: 16/758,569

(22) PCT Filed: Oct. 24, 2018
(86) PCT No.: PCT/FR2018/052648

§ 371 Date: Apr. 23, 2020

(30) Foreign Application Priority Data
Oct. 24, 2017 (FR) 1760050

(51) Int. Cl. F24H 3/04; B60H 1/22

(52) U.S. Cl. CPC F24H 3/0429; B60H 1/2225; H05B 2203/023; B60H 2001/2287; B60H 2001/2278; F24H 2250/04

(57) ABSTRACT

Heating device (1), particularly for air conditioning housing of a motor vehicle, wherein the device (1) comprises a heating module (2) configured to heat a flow of air using an electrical current circulating in the module (2), said heating module (2) defining a plurality of zones (7, 8), each zone (7, 8) being capable of heating the flow of air in the direction of one portion of a passenger compartment of said motor vehicle, each of said zones (7, 8) comprising a plurality of heating elements (3) and wherein at least one of said zones (7, 8) comprises a number of heating elements (3) that is different from a number of heating elements (3) heating another of said zones (7, 8).

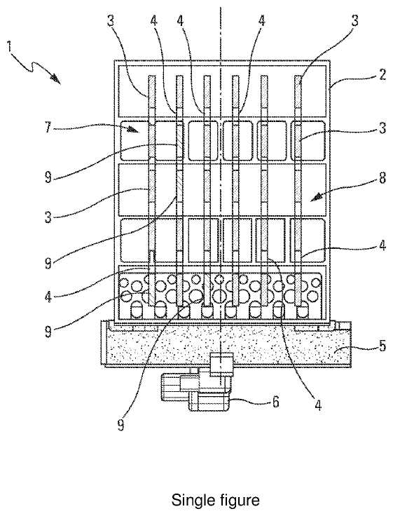

The present invention relates to a heating device, particularly for an air conditioning housing of a vehicle.

There are known electric heating devices designed to be integrated into vehicle air conditioning housings. These are either additional radiators, combined with heating radiators through which a heat-transfer fluid flows, in combustion-engine vehicles, or main radiators in electric or hybrid vehicles.

Such heating devices may comprise a support frame receiving, on the one hand, a heating body comprising heating elements arranged parallel to one another and, on the other hand, electrical tracks powering the heating elements from connecting terminals. More sophisticated heating devices also comprise means for controlling the current powering the heating elements.

Heating devices are energy-hungry and thus represent a significant energy consumption item. Motor vehicle constructors thus seek to reduce heating device consumption with a view to reducing the fuel consumption of vehicles equipped with an internal combustion engine or to increasing the range of vehicles equipped with electric or hybrid engines.

The applicant has become aware that passengers in one and the same motor vehicle do not have the same requirements in terms of heated air. At a given temperature in the car interior, the driver does not feel the cold in the same way as do the other passengers who are more sensitive.

Known heating devices consume the same energy continuously, whether the heated air is intended for one person or more than one person seated in the car interior of the motor vehicle for a given air temperature, which translates into a loss of energy insofar as the air is heated for no reason.

An object of the invention is to at least in part palliate the above-mentioned drawbacks and to that end proposes a heating device, particularly for an air-conditioning housing of a motor vehicle, wherein the device comprises a heating module configured such as to heat a flow of air using an electric current circulating in said module, said heating module defining a plurality of zones, each zone being capable of heating the flow of air in the direction of a part of a car interior of said motor vehicle, each of said zones comprising a plurality of heating elements, and wherein at least one of said zones comprises a number of heating elements that is different from a number of heating elements of another of said zones.

Such a heating device offers the advantage of saving energy by reducing electrical consumption, promoting greater range particularly when the vehicle comprises a propulsion engine of the electric or hybrid vehicle.

According to other features of the invention, which may be taken together or separately:
the device wherein it comprises at least two zones, a first zone designed to heat the flow of air in the direction of the driver and a second zone designed to heat the flow of air in the direction of a front passenger of the motor vehicle;
the device wherein the first zone comprises a number N1 of heating elements and the second zone comprises a number N2 of heating elements, the number N1 being less than the number N2;
the device wherein the heating elements have an electrical resistor dependent on the temperature of said heating elements;
the device wherein the heating elements are positive temperature coefficient heating elements;
the device wherein the heating elements are arranged in bars, each zone comprising a plurality of bars;
the device wherein each bar is controlled independently of one another;
the device wherein the bars of one and the same zone are controlled in such a manner that a voltage and an identical current are conveyed in each bar of one and the same zone;
the device wherein each bar of the first zone comprises heating elements and at least one non-heating element;
the device wherein a non-heating element of a bar is arranged in such a manner as to lie next to a heating element of another bar;
device wherein each bar of the second zone comprises five heating elements;
device wherein the first zone comprises three bars;
device wherein:
   a first bar of the first zone comprises four heating elements followed by a non-heating element,
   a second bar of the first zone and next to the bar and comprising a heating element followed by two non-heating elements followed by two heating elements,
   a third bar of the first zone and next to the second bar and identical to the first bar.

The invention will be better understood and further details, features and advantages of the invention will become apparent on reading the following description given by way of non-limiting example and with reference to the figure that schematically illustrates in front view a heating device according to the invention.

As illustrated in the figure, the invention relates to a heating device 1, particularly for a motor vehicle air conditioning housing.

Said device 1 comprises a heating module 2 configured such as to heat a flow of air using an electric current circulating through said heating module 2. Said heating module 2 here has a substantially parallelepipedal configuration, extending as a surface. It is designed to be positioned transversally relative to the flow of air to be heated up.

Although not shown in detail in the figure, said heating module 2 comprises, for example, a support frame, particularly made from plastics material, receiving one or more heating elements. Said heating elements comprise, for example, resistors with a PTC (“positive temperature coefficient”) effect. Each heating element advantageously forms a bar 4 receiving the PTC-effect resistors 3 or normal resistors 3, the latter being located one after the other and connected electrically in parallel. In a preferred embodiment, the resistors 3 are PTC-effect resistors. The heating element 3 may further comprise dissipators, for example fins in a thermal contact relationship with the PTC-effect resistors 3. The dissipators are positioned, in particular, on either side of said resistors 3.

Said device 1 further comprises a unit 5 for distribution and control of the current in said heating module 2 and a power connector 6 for said current, making it possible to make the connection to the electrical source of the motor vehicle.

Said distribution unit 5 advantageously forms a connection and distribution interface for electrically connecting the heating module 2, in particular the various heating elements 3, to a current supply network of the vehicle, for example a 12 V DC (direct current) or 48 V DC network or the like, particularly a network integrating a battery of the vehicle “Connection and distribution interface” is understood to mean that the distribution unit 5 is sufficient to allow the circulation of the current in the heating module 2 without provision having to be made in said heating module 2 for one or more specific terminals connecting to the current supply network of the vehicle.

Said distribution unit 5 is configured such as to modulate the current powering the heating module 2, in particular the various heating elements, for example with the aid of controlled commutators, making it possible to control a circulation of current in said heating module 2. These are, in particular, transistors, for example of the MOSFET or IGBT type, functioning in particular by pulse width modulation (PWM).

The heating module 2 and the distribution unit 5 are configured such as to be assembled together in a modular or non-modular manner.

According to the invention, the heating module 2 defines a plurality of zones 7, 8. In the embodiment shown in the figures, the heating module 2 comprises two zones 7, 8: a first zone 7 heating the flow of air intended for the driver and a second zone 8 heating the flow of air intended for the front passenger(s).

As stated above, the heating module 2 comprises heating elements 3. The heating elements 3 comprise resistors that may be manufactured from a variety of materials. However, a preferred material is PTC-effect ceramic because this is a material with a positive temperature coefficient and has particularly advantageous properties in the invention. In particular, its resistance varies as a function of its temperature and thus the resistance increases when its temperature increases, and vice versa. This makes it possible advantageously to reduce the consumption of said ceramics.

As illustrated in the figure, the first zone 7 comprises a number N1 of heating elements 3. The second zone 8 comprises a number N2 of heating elements 3.

The number N1 is less than the number N2. Thus, the air intended for the driver is heated by fewer heating elements 3 than is the air that reaches the passenger.

The heating elements 3 are arranged in the bars 4. Each zone 7, 8 comprises a plurality of bars 4. The heating elements 3 of one and the same bar 4 are powered by electrodes common to all the heating elements 3 of the bar 4. A bar 4 has the form of a profile comprising heating elements 3 spaced out relative to one another. A bar 4 also comprises electrodes common to the heating elements 3.

The electric current conveyed and the voltage applied to each bar 4 in one and the same zone 7, 8 is identical.

In a variant embodiment, each bar 4 is controlled independently. Thus, the electric current and the voltage applied are different from one bar 4 to another. This makes it possible advantageously to control the heating of the air more precisely.

In the embodiment shown in the figure, each bar 4 of the first zone 7 comprises heating elements 3 and at least one non-heating element 9.

“Non-heating element” is understood to mean elements that do not heat, such as, for example, false ceramics or separation elements made from plastics materials. However, a non-heating element 9 may also be an empty space.

An empty space is particularly advantageous in that it makes it possible to reduce costs and makes the device 1 easier to manufacture. However, a non-heating element 9, such as a false ceramic, offers the advantage that the support frame has improved structural rigidity.

As illustrated in the figure, a non-heating element 9 of a bar 4 is arranged in such a manner as to be next to a heating element 3 of another bar 4. This makes it possible advantageously to not have too great a non-heating surface. Indeed, too great a non-heating surface could be detrimental to the heat quality of the air such that the driver or the passenger would sense differences in temperature in the flow of air.

In the non-limiting exemplary embodiment shown in the figure, the first zone 7 and the second zone 8 each comprise three bars 4. Each bar 4 of the second zone 8 comprises five heating elements 3.

In the embodiment shown in the figure, the device 1 comprises a first bar 4 located in the first zone 7 and comprising four heating elements 3, followed by a non-heating element 9. The device 1 comprises a second bar 4 located in the first zone 7 and next to the first bar 4 and comprising a heating element 3 followed by two non-heating elements 9 followed by two heating elements 3. The device 1 comprises a third bar 4 located in the first zone 7, next to the second bar 4 and identical to the first bar 4. In each bar 4, the heating and non-heating elements 3, 9 are arranged in a row.

Fewer heating elements in the first zone 7 as compared to the second zone 8 means that the air in the direction of the driver will be heated less. a priori this would seem to reduce driver comfort. However, the applicant has become aware that the driver does not sense the temperature in the same manner as the front passenger does. As a result, fewer heating elements 3 in the first zone 7 does not reduce the thermal comfort perceived by a driver.

The heating device 1 just described offers the advantage of saving energy by reducing electrical consumption, affording greater range particularly when the vehicle comprises a propulsion engine of the electric or hybrid vehicle.

1. A heating device for an air-conditioning housing of a motor vehicle, the device comprising:
a heating module configured such as to heat a flow of air using an electric current circulating in said module,
said heating module defining a plurality of zones, each zone being capable of heating the flow of air in the direction of a part of a car interior of said motor vehicle,
each of said zones comprising a plurality of heating elements, and
wherein at least one of said zones comprises a number of heating elements that is different from a number of heating elements of another of said zones.

2. The device as claimed in claim 1, further comprising at least two zones of the plurality of zones comprising a first zone to heat the flow of air in the direction of a driver and a second zone to heat the flow of air in the direction of a front passenger of the motor vehicle.

3. The device as claimed in claim 2, wherein the first zone comprises a number N1 of heating elements and the second zone comprises a number N2 of heating elements, the number N1 being less than the number N2.

4. The device as claimed in claim 3, wherein the heating elements N1 and N2 have an electrical resistor dependent on the temperature of said heating elements.

5. The device as claimed in claim 4, wherein the heating elements are positive temperature coefficient heating elements.

6. The device as claimed in claim 5, wherein the heating elements are arranged in bars, each zone of the at least two zones comprising a plurality of bars.

7. The device as claimed in claim 6, wherein each bar is controlled independently of one another.

8. The device as claimed in claim 6, wherein the bars of one and the same zone are controlled in such a manner that a voltage and an identical current are conveyed in each bar of one and the same zone.

9. The device as claimed in claim 6, wherein each bar of the first zone comprises heating elements and at least one non-heating element.

10. The device as claimed in claim 9, wherein a non-heating element of a bar is arranged in such a manner as to lie next to a heating element of another bar.

11. A heating device for an air-conditioning housing of a motor vehicle, comprising:
a heating module configured to heat a flow of air using an electric current circulating in said heating module, the heating module being substantially parallelepipedal and extending as a surface, positioned transversally relative to the flow of air to be heated,
said heating module defining a plurality of zones, each zone being capable of heating the flow of air in the direction of a part of a car interior of said motor vehicle,
each of said zones comprising a plurality of heating elements,
wherein at least one of said plurality of zones comprises a number of heating elements that is different from a number of heating elements of another of said plurality of zones.

12. An assembly, comprising:
a heating device comprising:
a heating module configured to heat a flow of air using an electric current circulating in said heating module,
said heating module defining a plurality of zones, each zone being capable of heating the flow of air in the direction of a part of a car interior of said motor vehicle,
each of said zones comprising a plurality of heating elements,
wherein at least one of said plurality of zones comprises a number of heating elements that is different from a number of heating elements of another of said plurality of zones; and
a distribution unit configured to form a connection and distribution interface for electrically connecting the heating module to a current supply network of the vehicle,
the distribution unit being further configured to modulate the current powering the heating module and the plurality of heating elements with the aid of controlled commutators.
